(19) United States
(12) Patent Application Publication
(10) Pub. No.: US 2024/0100772 A1
(43) Pub. Date: Mar. 28, 2024

(54) DEVICES AND SYSTEMS FOR VARYING FILAMENT PATH LENGTH

(71) Applicant: MARKFORGED, INC., Waltham, MA (US)

(72) Inventors: Benjamin Fine, Somerville, MA (US); Nathaniel Berman, Somerville, MA (US); Angus MacMullen, Cambridge, MA (US); David Piper, Leominster, MA (US); Nicholas Kalweit, Cambridge, MA (US); Peter Kelly, Boston, MA (US)

(21) Appl. No.: 18/371,273

(22) Filed: Sep. 21, 2023

Related U.S. Application Data
(60) Provisional application No. 63/410,678, filed on Sep. 28, 2022.

(51) Int. Cl. B29C 64/209; B29C 64/118; B33Y 30/00

(52) U.S. Cl. CPC B29C 64/209; B29C 64/118; B33Y 30/00

(57) ABSTRACT

A three-dimensional printer for the additive manufacturing of a part is provided. The printer includes a build platen, a pre-extrusion system, and a print head located downstream of the pre-extrusion system and configured to receive and deposit a filament. The print head includes a receiving section configured to receive the filament, an outlet through which the filament is deposited onto the build platen or a previously added layer of a part, a feeding mechanism constructed and arranged to feed the filament into the outlet, and a path length adjustment system positioned on the print head disposed between the pre-extrusion system and the feeding mechanism. The path length adjustment system constructed and arranged to create slack in the filament being delivered from the pre-extrusion system. Path length adjustment devices incorporating sliding components and flexure components are also disclosed.

### CROSS-REFERENCE TO RELATED APPLICATIONS

This application claims priority to U.S. Patent Application No. 63/410,678, filed Sep. 28, 2022, the entire contents of which are incorporated herein by reference in their entirety.

### FIELD OF TECHNOLOGY

Aspects and embodiments disclosed herein relate to device and systems for varying the filament path length in a three-dimensional printer and managing the feed rate of said filament.

### SUMMARY

In accordance with an aspect, there is provided a three-dimensional printer for the additive manufacturing of a part. The printer may include a build platen, a pre-extrusion system, and a print head located downstream of the pre-extrusion system and configured to receive and deposit a filament. The print head may include a receiving section configured to receive the filament. The receiving section can include an inlet through which the filament is threaded. The print head may include an outlet through which the filament is deposited onto the build platen or a previously added layer of a part. The print head further can include a feeding mechanism constructed and arranged to feed the filament into the outlet. The print head additionally can include a path length adjustment system positioned on the print head disposed between the pre-extrusion system and the feeding mechanism. The path length adjustment system can be constructed and arranged to create slack in the filament being delivered from the pre-extrusion system.

In some embodiments, the path length adjustment system of the print head may include a housing connected to the print head and comprising an open side and a central space. The path length adjustment system may include a sliding component constructed and arranged to translate along the open side of the housing, the sliding component may have a first portion that sits within the central space and a second portion that projects away from the open side. The path length adjustment system further may include an inner bushing positioned within the first portion of the sliding component and having a diameter adapted to pass a filament therethrough. The sliding component adjusting a path length of the filament in response to a pressure on the filament during a printing process.

In some embodiments, the sliding component includes a component constructed and arranged to provide a bias force in an opposing direction to a filament feed. In some embodiments, the sliding component includes a component constructed and arranged to provide a bias force aligned with a filament feed direction. In specific embodiments, the component constructed and arranged to provide a bias force is a spring. For example, one or more springs may be coupled to one or both of the sliding component and the housing. In specific embodiments, the component constructed and arranged to provide a bias force is a magnet positioned on the sliding component opposing a magnet positioned in the housing.

In some embodiments, the second portion of the sliding component may include a magnet disposed along a feed path of the filament through the path length adjustment system. The path length adjustment system can provide for a path length adjustment range of about 0.5 mm to about 1.5 mm, e.g., about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, or about 1.5 mm.

In some embodiments, the sliding component is manufactured from a polymer.

In some embodiments, the path length adjustment system of the print head may include a central body having a top, a bottom, and a passage therethrough. The central body can be aligned with the filament direction through the print head. The path length adjustment system can include a first flexure having a first end connected to the top of the central body and a second end connected to the print head. The path length adjustment system further may include a second flexure having a first end connected to the bottom of the central body and a second end connected to the print head. The central body can pivot between the first flexure and second flexure to adjust a path length of the filament in response to a pressure on a filament during a printing process.

In some embodiments, the central body may include a magnet disposed along a feed path of the filament through the path length adjustment system.

In some embodiments, the central body may provide for a path length adjustment range of about 0.5 mm to about 3.0 mm, e.g., about 0.5 mm to about 3.0 mm, about 0.75 mm to about 2.75 mm, about 1.0 mm to about 2.5 mm, about 1.25 mm to about 2.25 mm, or about 1.5 mm to about 2.0 mm, e.g., about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, or about 3.0 mm.

In any embodiment described herein, the print head may include a sensor constructed and arranged to measure the linear position of the path length adjustment system. For example, the sensor may interact with the magnet located on the path length adjustment system to provide an output corresponding to a metric for the length of the path length of the filament.

In further embodiments, the printer may include a controller constructed and arranged to direct one or both of the feed mechanism and the pre-extruder to feed the filament to the print head. In certain embodiment, the controller may be configured to adjust the feed rate of the printer at one or both of the pre-extrusion system and feeding mechanism based on an output from the sensor in the path length adjustment system.

In accordance with an aspect, there is provided a device for adjusting a filament path length in a three-dimensional printer, comprising a movable component having a passage therethrough attached to a print head, the passage sized to pass the filament. The movable component may adjust a path length of the filament in response to a pressure on the filament during a printing process by moving along a long axis of the filament.

In some embodiments, wherein the movable component may be disposed within an open sided housing that permits the movable component to translate within the housing. The movable component may have a first portion that sits within the housing and a second portion that projects away from the open side of the housing. In further embodiments, the movable component may include an inner bushing positioned within the first portion of the sliding component and having a diameter adapted to pass a filament therethrough.

In some embodiments, the movable component may include a central body having a top, a bottom, and a passage therethrough, a first flexure having a first end connected to the top of the central body and a second end, and a second flexure having a first end connected to the bottom of the central body and a second end. The central body may be aligned with the filament direction through a print head of the three-dimensional printer.

In some embodiments, the movable component, e.g., a sliding component, includes a component constructed and arranged to provide a bias force in an opposing direction to a filament feed. In some embodiments, the movable component, e.g., a sliding component, includes a component constructed and arranged to provide a bias force in a direction aligned to a filament feed. In specific embodiments, the component constructed and arranged to provide a bias force is a spring. In specific embodiments, the component constructed and arranged to provide a bias force is a magnet positioned on the sliding component opposing a magnet positioned in the housing.

In some embodiments, the movable component may provide for a path length adjustment range of about 0.5 mm to about 3.0 mm, e.g., about 0.5 mm to about 3.0 mm, about 0.75 mm to about 2.75 mm, about 1.0 mm to about 2.5 mm, about 1.25 mm to about 2.25 mm, or about 1.5 mm to about 2.0 mm, e.g., about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, or about 3.0 mm.

In some embodiments, the movable component is manufactured from a polymer. In some embodiments, the movable component may include a magnet disposed along a feed path of the filament through the path length adjustment system.

In accordance with an aspect, there is provided a device for adjusting a path length in a three-dimensional printer. The device may include a housing connected to a print head of a three-dimensional printer. The housing may include an open side and a central space. The device may include a sliding component constructed and arranged to translate along the open side of the housing. The sliding component may have a first portion that sits within the central space and a second portion that projects away from the open side. The device further may include an inner bushing positioned within the first portion of the sliding component and having a diameter adapted to pass a filament therethrough. The sliding component may adjust a path length of the filament in response to a pressure on the filament during a printing process.

In accordance with an aspect, there is provided a device for adjusting a path length in a three-dimensional printer. The device may include a central body having a top, a bottom, and a passage therethrough. The central body of the device may be aligned with the filament direction through a print head of the three-dimensional printer. The device may include a first flexure having a first end connected to the top of the central body and a second end. The second end of the first flexure may be connected to the print head. The device further may include a second flexure having a first end connected to the bottom of the central body and a second end. The second end of the second flexure may be connected to the print head. The central body may pivot between the first flexure and second flexure to adjust a path length of the filament in response to a pressure on a filament during a printing process.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates a three-dimensional printer including a path length adjustment system incorporated into a print head, according to an embodiment.

FIGS. 2A-2B illustrate a path length adjustment device, according to an embodiment. FIG. 2A illustrates the path length adjustment device standalone. FIG. 2B illustrates the path length adjustment device of FIG. 2A positioned inside of a print head of a three-dimensional printer.

FIG. 3 illustrates a path length adjustment device, according to another embodiment. Further shown in FIG. 3 are the positions of magnets and sensors of the path length adjustment device.

FIGS. 4A-4C illustrate a path length adjustment device, according to another embodiment. FIG. 4A illustrates the path length adjustment device standalone. FIG. 4B illustrates a cross section of the path length adjustment device of FIG. 4A positioned inside of a print head of a three-dimensional printer illustrating additional components of the print head. FIG. 4C illustrates a zoomed-out view of the path length adjustment device of FIG. 4A positioned inside of a three-dimensional printer.

FIGS. 5A-5D illustrate a path length adjustment device, according to another embodiment. FIG. 5A illustrates a front view of the path length adjustment device. FIG. 5B illustrates a front corner view of the path length adjustment device. FIG. 5C illustrates a top-down view of the path length adjustment device. FIG. 5D illustrates a top-down view of the path length adjustment device installed into a three-dimensional printer.

FIGS. 6A-6E illustrate a path length adjustment device, according to another embodiment. FIG. 6A illustrates a side view of the path length adjustment device. FIG. 6B illustrates a front view of the path length adjustment device. FIG. 6C illustrates a front corner view of the path length adjustment device. FIG. 6D illustrates a cross section view of the path length adjustment device showing a stepped central body. FIG. 6E illustrates a side view of a path length adjustment device, according to an embodiment.

FIGS. 7A-7C illustrate a path length adjustment device, according to another embodiment. FIG. 7A illustrates a bottom side view of a sliding component. FIG. 7B illustrates a side view of a housing. FIG. 7C illustrates a side view of the path length adjustment device.

FIG. 8 illustrates a plot showing the position of the movable component of a path length adjustment device during a printing run though a print head depositing a 500 mm/min.

The features and advantages of the disclosure are apparent from the detailed specification, and thus, it is intended that the appended claims cover all systems and methods falling within the true spirit and scope of the disclosure. As used herein, the indefinite articles “a” and “an” mean “at least one” or “one or more.” Similarly, the use of a plural term does not necessarily denote a plurality unless it is unambiguous in the given context. Words such as “and” or “or” mean “and/or” unless specifically directed otherwise. In this application, the terms “comprising” and “including” may be understood to encompass itemized components or steps whether presented by themselves or together with one or more additional components or steps. Unless otherwise stated, the terms “about” and “approximately” may be understood to permit standard variation as would be understood by those of ordinary skill in the art. Where ranges are provided herein, the endpoints are included. As used in this application, the term “comprise” and variations of the term, such as “comprising” and “comprises,” are not intended to exclude other additives, components, integers or steps.

As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Many methodologies described herein include a step of “determining.” Those of ordinary skill in the art, reading the present specification, will appreciate that such “determining” can utilize or be accomplished through use of any of a variety of techniques available to those skilled in the art, including for example specific techniques explicitly referred to herein. In some embodiments, determining involves manipulation of a physical sample. In some embodiments, determining involves consideration and/or manipulation of data or information, for example utilizing a computer or other processing unit adapted to perform a relevant analysis. In some embodiments, determining involves receiving relevant information and/or materials from a source. In some embodiments, determining involves comparing one or more features of a sample or entity to a comparable reference.

As used herein, the term “substantially,” and grammatic equivalents, refer to the qualitative condition of exhibiting total or near-total extent or degree of a characteristic or property of interest. One of ordinary skill in the art will understand that chemical phenomena rarely, if ever, go to completion and/or proceed to completeness or achieve or avoid an absolute result.

### DETAILED DESCRIPTION

Among other things, the present disclosure provides composite objects including an internal component made from a printable material and an outer component formed from a castable material, i.e., a polymer or resin. Methods for manufacturing these types of composite objects are also disclosed herein. Various embodiments according to the present disclosure are described in detail herein.

Additive manufacturing, sometimes more generally known as three-dimensional printing, refers to a class of technologies for the direct fabrication of physical products from a three-dimensional computer model by a layered manufacturing process. In contrast to material removal processes in traditional subtractive manufacturing, the three-dimensional printing process adds material. In additive manufacturing, 3D parts are manufactured by adding layer-upon-layer of material. For example, an additive manufacturing-based 3D printing device can create a 3D part, based on a digital representation of the part, by depositing a part material along toolpaths in a layer-by-layer manner. This process can enable the direct printing of products with extremely complex geometry.

Fused Deposition Modeling (FDM) also referred to as Fused Filament Fabrication (FFF) is an example of additive manufacturing technology used for modeling, production, and prototyping. In an FDM, FFF additive manufacturing process, a moving print head extrudes a filament of material onto a print bed or to an object being printed. The print head and/or the print bed can move relative to each other under computer control to define the printed object. Additive manufacturing of a layer generally involves slicing a two-dimensional layer into a series of shells, that is beads, lines, or shells that are stacked on top of one another (that is, along the z-axis) forming a digital representation of the intended part. The printing of a layer is typically done shell-by-shell on a build plate or print bed until the one or more shells (i.e., the plurality of shells) are complete, e.g., by incrementing the position of the print head relative to the substrate along one or more print axes. For example, each two-dimensional layer may have a number of shells lining a contour, such as a perimeter of a wall. This process can then be repeated to form an object, i.e., a three-dimensional part, resembling the digital representation. The process of depositing or extruding shells is typically in a machine-controlled manner according to slicing parameters. Additionally, for example, printing of subsequent shells may include extruding by tracing along a contour or path defined by a prior printed shell. A result of such a process can be a repeatable and consistent extrusion. Moreover, each two-dimensional layer may have a different fill pattern filling the interior of the part. Additionally, a fill pattern may be deposited between an inner and an outer perimeter of a wall.

In a fused deposition additive manufacturing system, a three-dimensional part or model may be printed from a digital representation of the three-dimensional part in a layer-by-layer manner by extruding a flowable part material along toolpaths.

The print head can move in two dimensions to deposit one horizontal plane of material to form a layer of the object being printed. Then, the print head or the print bed can be moved vertically by a small amount to begin another horizontal plane of material to form a new layer of the object. The part material is extruded through an extrusion tip carried by a print head of a three-dimensional printing apparatus, device, or system. Part material is deposited as a sequence of roads on a substrate in a build plane. A layer, for example, a first layer of a printable material is deposited (i.e., extruded) onto the build surface. That is, for example, a horizontal layer is printed with movement in the X-Y axis. Once this first horizontal layer is completed, a height adjustment is made in the Z axis. Another horizontal layer of is printed with movement in the X-Y axis. Once the next horizontal layer is completed, another height adjustment is made in the Z axis. This process continues, for each layer until the object is completed.

For a three-dimensional printer to maintain consistent operation, the tension in the material being printed can be managed. In general, a filament has to have sufficient tension such that the filament does not fold over and jam the feeding mechanism but cannot be so taught that the filament cannot be fed to the print head. One configuration to manage the tension or slack in a filament being printed is through the use of a “slack box” installed at a suitable location in the filament feed path that provides for minute adjustments in the tension and path length as the filament is fed to the print head.

Existing slack management systems can present a number of issues when using filaments that are sensitive to the surrounding environment. For example, certain filament materials, e.g., nylon and carbon fiber composites, are hygroscopic and are subject to oxidation under ambient conditions. Under these conditions, a portion of a filament to be printed would likely have to be purged from the print head, which would result in the use of excess material and ultimately increase costs. Sealed slack management systems, e.g., systems containing devices for controlling the environment, e.g., humidity, around the filament being printed, are often cumbersome to use and maintain and generally require heat and purge gas supplies, increasing costs and maintenance. It is an object of the present disclosure to provide for a slack management system, i.e., devices for adjusting the filament path length of a three-dimensional printer, that are unsealed and minimize the length of filament exposed to the ambient environment via positioning the path length adjusting device on the print head.

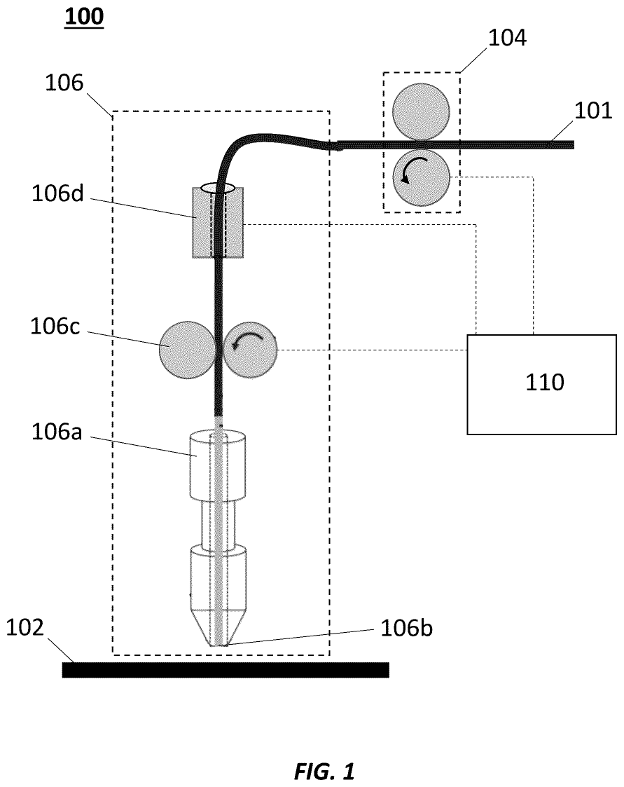

In certain non-limiting embodiments, this disclosure describes devices for adjusting the path length of a three-dimensional printer and printer systems incorporating the same. An embodiment of a three-dimensional printer is illustrated in FIG. 1. With reference to FIG. 1, a three-dimensional printer 100 for the additive manufacturing of a part includes a build platen 102, a pre-extrusion system 104, and a print head 106 located downstream of the pre-extrusion system 104 that is configured to receive and deposit a filament 101, e.g., onto the build platen 102. The print head 106 includes a receiving section 106a configured to receive the filament 101, an outlet 106b through which the filament 101 is deposited onto the build platen 102 or a previously added layer of a part, a feeding mechanism 106c constructed and arranged to feed the filament 101 into the outlet 106b, and a path length adjustment system 106d positioned on the print head 101 and disposed between the pre-extrusion system 104 and the feeding mechanism 106c. The receiving section 106a includes an inlet through which the filament 101 is threaded. The path length adjustment system 106d is constructed and arranged to create slack in the filament 101 being delivered from the pre-extrusion system 104. The slack in the filament 101 ahead of the feed mechanism 106c aids in providing a consistent supply of filament during a printing process and improved surface finish of the resulting parts. As discussed herein, in contrast to existing slack management devices with cumbersome and difficult to seal environments, the path length adjustment system 106d as illustrated in FIG. 1 is incorporated into the print head 101 to minimize exposed filament to the environment. As the print head generally operates under controlled conditions, e.g., includes heat sources, gas purge lines, and/or is positioned within an enclosure whose environment can be controlled, the path length adjustment system 106d as disclosed herein can operate under a dry environment and its close positioning to the outlet of the print head 101 minimizes the length of exposed filament to be purged ahead of a printing process. Operation under controlled, e.g., dry, conditions reduces tension on the feed mechanism and can improve the printing of hygroscopic materials, e.g., nylon and carbon composite filaments.

In some embodiments, such as illustrated in FIG. 1, the three-dimensional printer 100 includes a controller 110 constructed and arranged to direct the feed mechanism 106c to feed the filament 101 to the print head 106, e.g., from a filament supply. The controller 110 directs the feed mechanism to call for filament 101 during the printing process at a rate determined by the design of the part being printed, temperature changes of the print head 106 and the material of the filament 101 being printed, and the desired surface finish of the part. The feed rate of the printer 100 is a function of the movement rate of the pre-extrusion system 104 and feeding mechanism 106c, and excess tension of the filament can result in poor quality prints or broken filaments. In some embodiments, the controller 110 can be configured to adjust the feed rate of the printer 100 at one or both of the pre-extrusion system and feed mechanism 106c based on an output from the sensor in the path length adjustment system 106d. In operation, the sensor positioned in the filament feed path of the path length adjustment system 106d responds to the magnet incorporated into a movable component of the path length adjustment system 106d that moves in response to pressure on the filament. The magnet can induce a voltage change in the sensor, which is directly correlated to the path length of the filament. The controller 110 can accept the signal, e.g., voltage, from the sensor and control of the rate, e.g., rotational rate, of both the pre-extrusion system 104 and feeding mechanism 106c to permit slack in the filament 101 to build up at the entrance of the path length adjustment system 106d. Thus, when filament 101 is called for during printing, the filament 101 can be fed without tension, resulting in smooth printing.

The controller may be implemented using one or more computer systems. The computer system may be, for example, a general-purpose computer such as those based on an Intel CORE®-type processor, an Intel XEON®-type processor, an Intel CELERON®-type processor, an AMD FX-type processor, an AMD RYZEN®-type processor, an AMD EPYC®-type processor, and AMD R-series or G-series processor, or any other type of processor or combinations thereof. Alternatively, the computer system may include programmable logic controllers (PLCs), specially programmed, special-purpose hardware, for example, an application-specific integrated circuit (ASIC) or controllers intended for analytical systems. In some embodiments, the controller may be operably connected to or connectable to a user interface constructed and arranged to permit a user or operator to view relevant operational parameters of the printer 100, adjust said operational parameters, and/or stop operation of the printer 100 as needed. The user interface may include a graphical user interface (GUI) that includes a display configured to be interacted with by a user or service provider and output status information of the three-dimensional printer.

The controller can include one or more processors typically connected to one or more memory devices, which can comprise, for example, any one or more of a disk drive memory, a flash memory device, a RAM memory device, or other device for storing data. The one or more memory devices can be used for storing programs and data during operation of the three-dimensional printer. For example, the memory device may be used for storing historical data relating to the parameters over a period of time. Software, including programming code that implements embodiments of the invention, can be stored on a computer readable and/or writeable nonvolatile recording medium, and then typically copied into the one or more memory devices wherein it can then be executed by the one or more processors. Such programming code may be written in any of a plurality of programming languages, for example, ladder logic, Python, Java, Swift, Rust, C, C#, or C++, G, Eiffel, VBA, or any of a variety of combinations thereof.

In general, a path length adjustment device attached to the print head of a three-dimensional printer includes a movable component having a passage therethrough that is sized to pass the filament. The movable component can adjust a path length of the filament in response to a pressure on the filament during a printing process by moving along a long axis of the filament. Without wishing to be bound by any particular theory, the movable component of the path length adjustment device provides for an interruption in the feed path of the filament being deposited by the print head. The movable component provides for the buildup of slack in the filament at the opening of the movable component. When the feed mechanism is directed to deposit filament, the slack in the filament provides for smooth motion of the filament, reducing tension on the filament and potential breaking of the filament during printing from the forces applied by the feed mechanism. The motion of the movable component can be synchronized to one or more other components of the three-dimensional printer, e.g., one or both of the pre-extrusion system or the feed mechanism.

A path length adjustment device includes a housing connected to a print head in a three-dimensional printer, the housing comprising an open side and a central space, a sliding component e.g., a movable component, constructed and arranged translate along the open side of the housing, and an inner bushing positioned within the first portion of the sliding component and having a diameter adapted to pass a filament therethrough. The sliding component includes a first portion that sits within the central space and a second portion that projects away from the open side. In operation, the sliding component adjusts a path length of the filament in response to a pressure on the filament during a printing process.

In other embodiments, a path length adjustment device includes a central body having a top, a bottom, and a passage therethrough, the central body, e.g., a movable component, aligned with the filament direction through a print head of the three dimensional printer, a first flexure having a first end connected to the top of the central body and a second end, and a second flexure having a first end connected to the bottom of the central body and a second end. In this configuration, the central body pivots between the first flexure and second flexure to adjust a path length of the filament in response to a pressure on a filament during a printing process.

In some embodiments, the path length adjustment system, e.g., the movable component of the path length adjustment system, provides for a path length adjustment range of about 0.5 mm to about 3.0 mm, e.g., about 0.5 mm to about 3.0 mm, about 0.75 mm to about 2.75 mm, about 1.0 mm to about 2.5 mm, about 1.25 mm to about 2.25 mm, or about 1.5 mm to about 2.0 mm, e.g., about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, or about 3.0 mm.

In general, the movable component of the path length adjustment system can be made from any suitable material. Without wishing to be bound by any particular theory, the material should provide for wear resistance, flexibility, and low friction when installed in proximity to components of the print head against which it moves. Example materials for the movable component include, but are not limited to, polyphenylene sulfide (PPS), nylon, polyether ether ketone (PEEK), and metals, e.g., aluminum and steel. In some embodiments, the material for the movable component may include one or more additives to improve mechanical properties, e.g., wear resistance and surface friction, such as polytetrafluoroethylene (PTFE, i.e., TEFLON®), carbon, and graphite, among others. When a metal is used for the movable component, the metal may include a surface treatment to improve wear resistance, such as hardening (for steel) and anodizing (for aluminum).

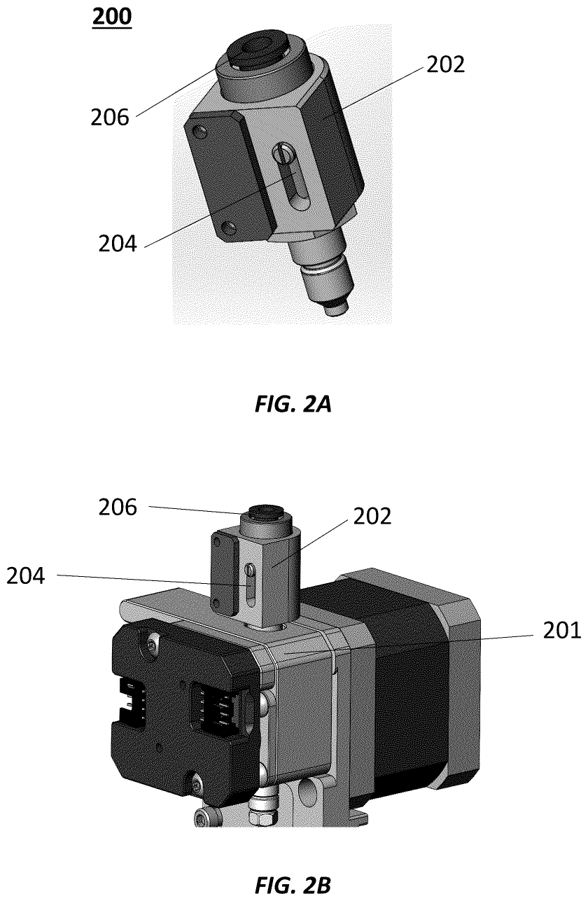

FIGS. 2A-7C illustrate various embodiments of path length adjustment devices constructed and arranged to be connected to the print head of a three-dimensional printer and positioned in the filament feed path between the pre-extrusion system and the feed mechanism. FIGS. 2A and 2B illustrate a linear path length adjustment device. With reference to FIG. 2A, the path length adjustment device 200 includes a housing 202 having a sliding component 204 constructed and arranged to translate along a length of the housing 202 and an inner bushing 206 positioned within the housing that is dimensioned to pass a filament therethrough. The path length adjustment device 200, being adapted to be connected to a print head of a three-dimensional printer, can include any other structural elements necessary to permit connection to the three-dimensional printer. For example, as illustrated in FIG. 2B, the housing 202 of the path length adjustment device 200 can include a connector and a nozzle outlet that interfaces with a corresponding interface on the print head 201. In operation, sliding component 204 permits the filament being directed into the path length adjustment device 200 to have slack in the area of the inner bushing 206. The sliding component 204, upon sensing pressure from the filament, translates within the housing 202 to advance a small portion of the slacked filament to the feed mechanism downstream of the path length adjustment device 200 with little to no tension, thus maintaining smoothness of the printing process.

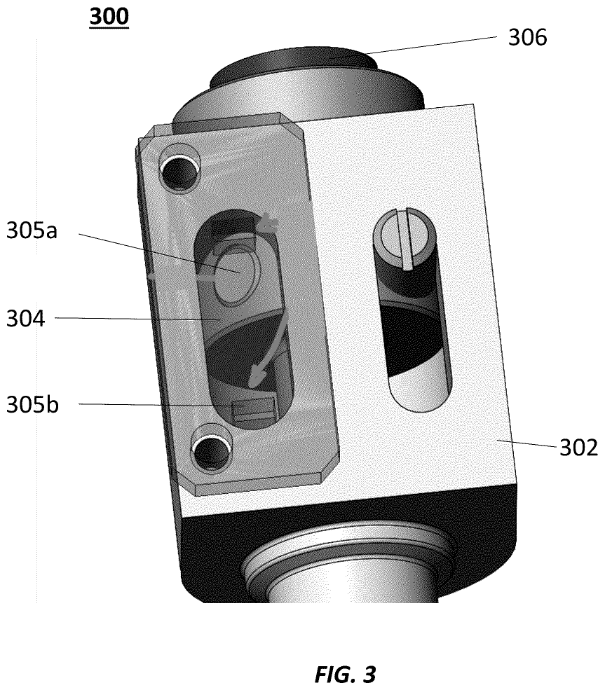

FIG. 3 illustrates the path length adjustment device 200 of FIGS. 2A-2B showing the position of a magnet 305a attached to the sliding component 304 and a suitable sensor 305b within the housing 302. In general, path length adjustment devices disclosed herein are used to provide a small adjustment of the path length of the filament being printed to ensure smooth operation of the feed mechanism during printing. The position of the sliding component 304 indicates how much filament is slacked ahead of the path length adjustment device 300 and how much filament can be released to the feed mechanism of the print head. As illustrated, the magnet 305a can induce a transverse electric field in the sensor 305b, e.g., a Hall sensor, to produce a voltage change that is directly proportional to the linear position of the sensor. Though illustrated as a magnet and Hall sensor, the sensor 305b can be any suitable sensor capable of measuring the positional change of the slidable component 304, and this disclosure is not limited to the type of sensors installed within the housing 302 of the path length adjustment device 300.

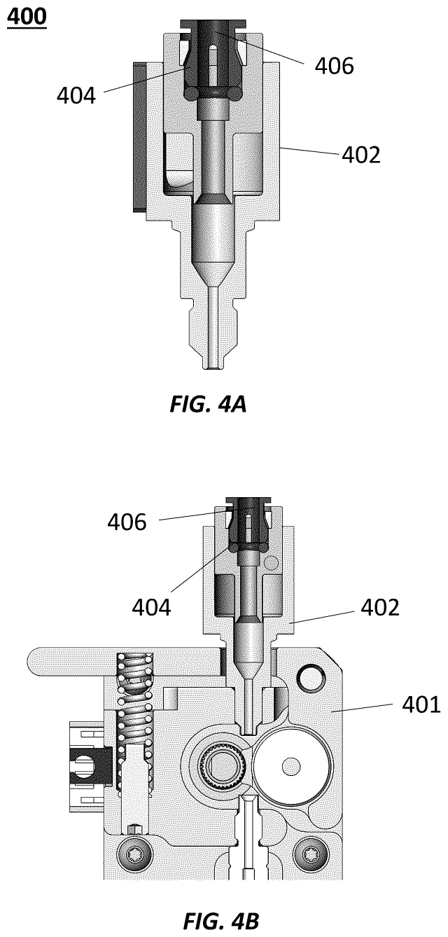

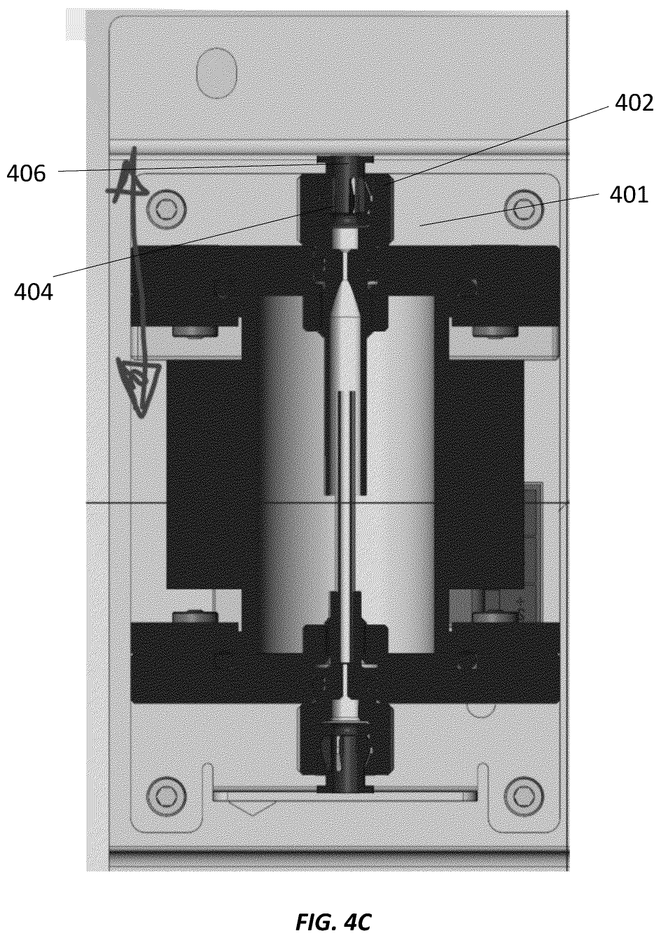

FIGS. 4A and 4B illustrate another embodiment of a linear path length adjustment device. With reference to FIG. 4A, the path length adjustment device 400 includes a housing 402 having a sliding component 404 constructed and arranged to translate along a length of the housing 402 and an inner bushing 406 positioned within the housing that is dimensioned to pass a filament therethrough. The path length adjustment device 400, being adapted to be connected to a print head of a three-dimensional printer, can include any other structural elements necessary to permit connection to the three-dimensional printer. For example, as illustrated in FIG. 4B, the housing 402 of the path length adjustment device 400 can include a connector and a nozzle outlet that interfaces with a corresponding interface on the print head 401. In operation, sliding component 404 permits the filament being directed into the path length adjustment device 400 to have slack in the area of the inner bushing 406. The sliding component 404, upon sensing pressure from the filament, translates within the housing 402 to advance a small portion of the slacked filament to the feed mechanism downstream of the path length adjustment device 400 with little to no tension, thus maintaining smoothness of the printing process. FIG. 4C illustrates the path length adjustment device installed in a larger printer. As illustrated by the arrow, the sliding component 404 translates within the housing 402 to allow a portion of the slacked filament to be delivered to the feed mechanism of the print head 401.

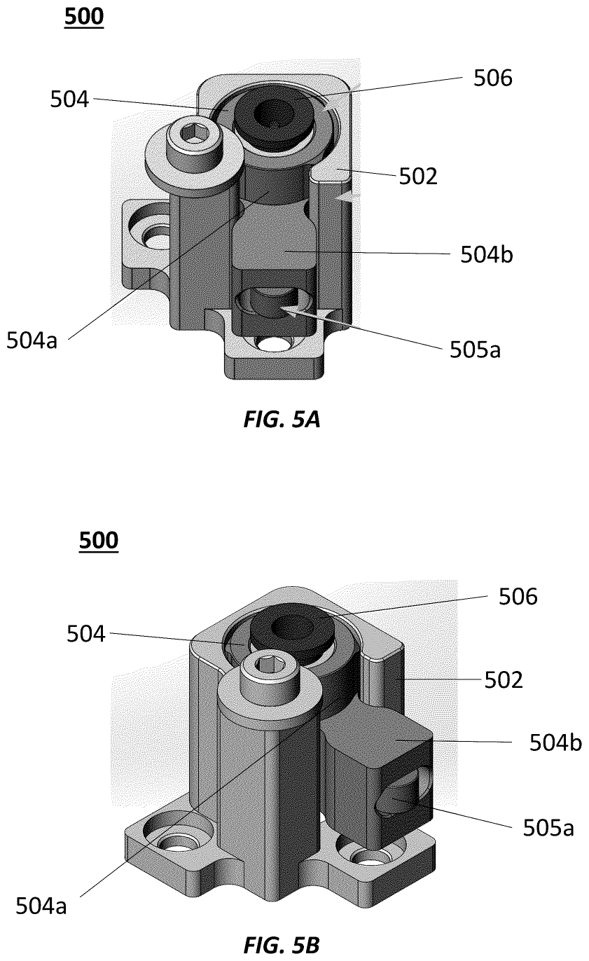

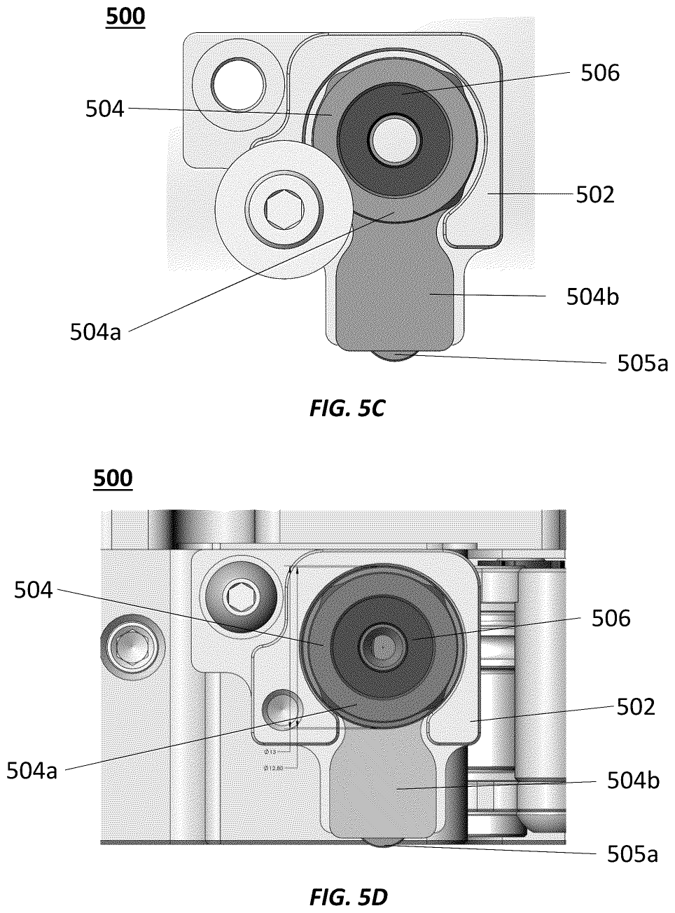

FIGS. 5A-5D illustrate another embodiment of a linear path length adjustment device. With reference to FIG. 5A, the path length adjustment device 500 includes a housing 502 having a sliding component 505 constructed and arranged to translate along a length of the housing 502 and an inner bushing 506 positioned within the housing that is dimensioned to pass a filament therethrough. The sliding component 504 can include structural features, such as the protrusions at its periphery illustrated in FIG. 5C, that provide a spacing away from the housing 502 and thus a path for debris to be directed away from the path length adjustment device 500, e.g., creating a space for debris to fall through such that the sliding component will not become clogged or jammed in operation. The path length adjustment device 500, being connected to a print head of a three-dimensional printer, can include any other structural elements necessary to permit connection to the three-dimensional printer. For example, as illustrated in FIGS. 5A-5C, the housing 502 of the path length adjustment device 500 can include molded holes in the housing 502 that allow it to be secured to the correct location on the print head, e.g., using screws, nuts, or another suitable fastener. FIG. 5D illustrates the attachment of the path length adjustment device 500 shown in FIGS. 5A-5C using threaded fasteners inserted through the molded holes in the housing. The inclusion of molded holes in the housing is only one type of attachment system, and this disclosure is not limited by the manner in which the housing 502 of the path length adjustment device 500 is secured to the print head. In operation, sliding component 504 permits the filament being directed into the path length adjustment device 500 to have slack in the area of the inner bushing 506. The sliding component 504, upon sensing pressure from the filament, translates within the housing 502 to advance a small portion of the slacked filament to the feed mechanism downstream of the path length adjustment device 500 with little to no tension, thus maintaining smoothness of the printing process.

As further illustrated in FIGS. 5A-5D, the magnet 505a can induce a transverse electric field in the sensor 505b, e.g., a Hall sensor, to produce a voltage change that is directly proportional to the linear position of the sensor. Though illustrated as a magnet and Hall sensor, the sensor 505b can be any suitable sensor capable of measuring the positional change of the slidable component 504, and this disclosure is not limited to the type of sensors installed within the housing 502 of the path length adjustment device 500. As further illustrated in FIGS. 5A-5D, the magnet 505a can induce a transverse electric field in a suitably positioned sensor, e.g., a Hall sensor, on the print head to produce a voltage change that is directly proportional to the linear position of the sensor. Though illustrated as a magnet and Hall sensor, the sensor can be any suitable sensor capable of measuring the positional change of the slidable component 504, and this disclosure is not limited to the type of sensors installed within the housing 502 of the path length adjustment device 500.

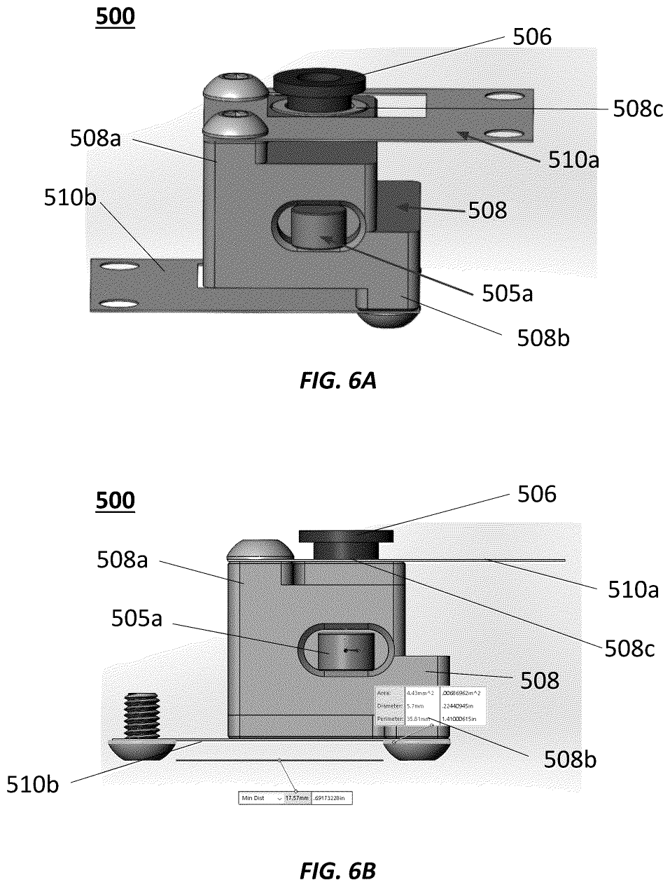

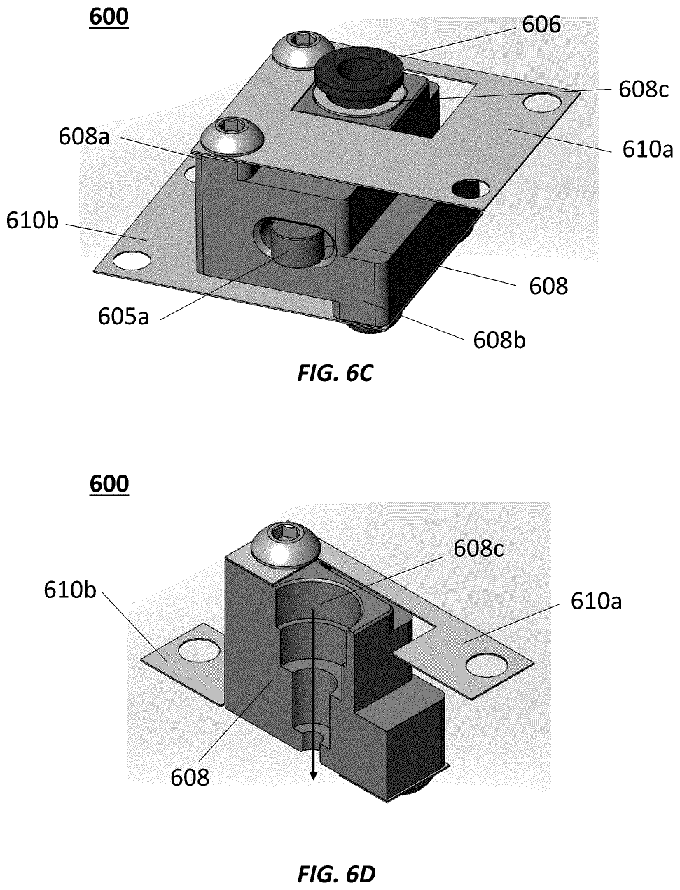

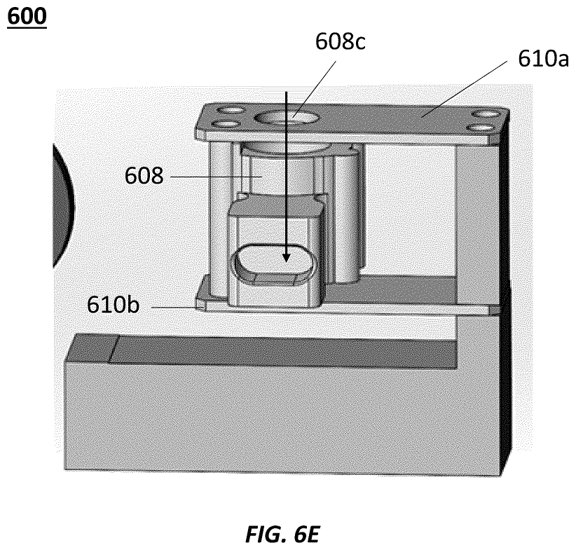

FIGS. 6A-6E illustrate another embodiment of a linear path length adjustment device. With reference to FIGS. 6A-6E, the path length adjustment device 600 includes a central body 608 having a top surface 608a, bottom surface 608b, and passage 608c therethrough. An inner bushing 606 is adapted into the entrance of the passage 608c. In operation, the central body 608 is aligned with the filament direction through a print head of the three-dimensional printer. The path length adjustment device 600 includes a first flexure 610a having a first end connected to the top 608a of the central body 608 and a second end and a second flexure 610b having a first end connected to the bottom 608b of the central body 608 and a second end. The first flexure 610a and second flexure 610b can be made from any suitable material than can flex and return to shape, such as polymers, metals, shape memory alloys, or other similar materials. In a specific non-limiting embodiment, the first flexure 610a and the second flexure 610b may be made from a spring steel or a steel shim stock. In FIGS. 6A-6D, the first flexure 610a and the second flexure 610b include holes through each corner that permit attachment to the central body 608 using a suitable fastener; as illustrated, the first end of each of the first flexure 610a and the second flexure 610b is attached to the central body 608 using a threaded fastener. This is only one embodiment, and the first end of each of the first flexure 610a and the second flexure 610b can attached to the central body 608 using any suitable attachment system or fastener type. The second end of each of the first flexure 610a and the second flexure 610b also include holes that permit attachment to the print head of the three-dimensional printer. As illustrated in FIG. 6B, the second end of each of the first flexure 610a and the second flexure 610b can be secured to the print head of the three-dimensional printer using a threaded fastener. This is only one embodiment, and the second end of each of the first flexure 610a and the second flexure 610b can attached to the print head of the three-dimensional printer using any suitable attachment system or fastener type. In operation, the central body 608 pivots between the first flexure 610a and the second flexure 610b to adjust a path length of the filament in response to a pressure on a filament during a printing process. This pivoting motion is approximately linear and permits slack in the filament to build up ahead of the central body 608 such that the feed mechanism of the printer can print smoothly when filament is called for.

As illustrated in FIGS. 6A-6D, the first flexure 610a and the second flexure 610b can be positioned on opposing sides of the central body 608 in a “Z-shaped” configuration. That is, the first flexure 610a extends over the right side of the central body 608 when attached to a top surface of the central body 608 and the second flexure 610b extends over the left side of the central body 608 when attached to a lower surface of the central body 608 (and vice-versa). This arrangement of the first flexure 610a and second flexure 610b is known as a Watts link, traditionally found on automotive suspensions to maintain a central position of an axle while an automobile drives and makes turns. An alternative arrangement similar to a Watts link is illustrated in FIG. 6E. In FIG. 6E, the first flexure 610a and the second flexure 610b can be positioned on the same side of the central body 608, with substantially identical functionality as the configuration illustrated in FIGS. 6A-6D. These configurations are only examples, and other flexure-based configurations, e.g., hinge-based motion and parabolic motion, i.e., trampoline motion, for pivoting a central body in accordance with this disclosure.

As further illustrated in FIGS. 6A-6D, the magnet 605a can induce a transverse electric field in a suitably positioned sensor on the print head, e.g., a Hall sensor, to produce a voltage change that is directly proportional to the linear position of the sensor. Though illustrated as a magnet and Hall sensor, the sensor can be any suitable sensor capable of measuring the positional change of the central body 608, and this disclosure is not limited to the type of sensors installed within the central body 608 of the path length adjustment device 600. As further illustrated in FIGS. 6A-6D, the magnet 605a can induce a transverse electric field in the sensor, e.g., a Hall sensor, to produce a voltage change that is directly proportional to the linear position of the sensor. Though illustrated as a magnet and Hall sensor, the sensor can be any suitable sensor capable of measuring the positional change of the central body 608, and this disclosure is not limited to the type of sensors installed within the central body 608 of the path length adjustment device 600.

In some embodiments, the sliding component can be biased in an opposing direction to the filament feed direction. In some embodiments, the movable component, e.g., the sliding component, can be biased in a direction aligned to the filament feed direction. Without wishing to be bound by any particular theory, a pre-extrusion force is exerted onto the filament to aid in overcoming the drag forces experienced by the filament as it traverses or slides through printer components. For certain filament materials, e.g., filaments that buckle or stretch when external forces are applied, pre-extrusion forces may be insufficient to permit feeding of the print head with enough force to actuate the path length adjustment device. In these situations, applying a bias force to the sliding component in a direction opposing the filament feed direction or aligned with the filament feed direction can provide an assisting force to actuate the sliding component.

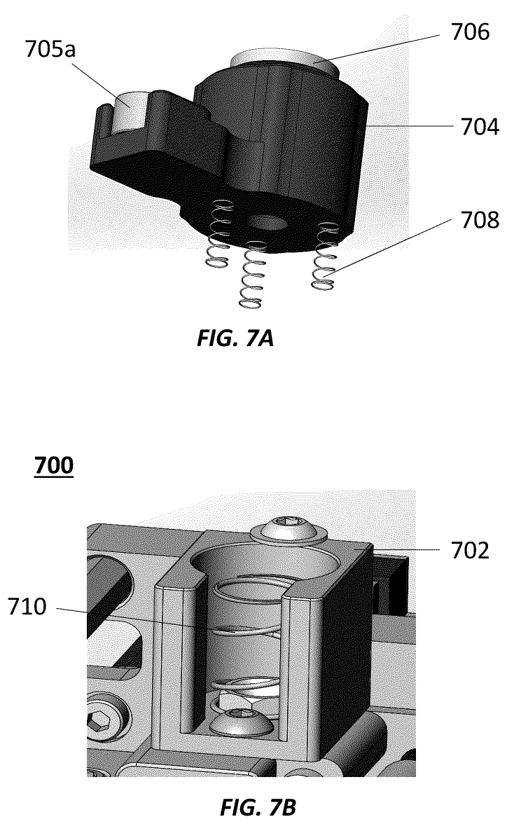

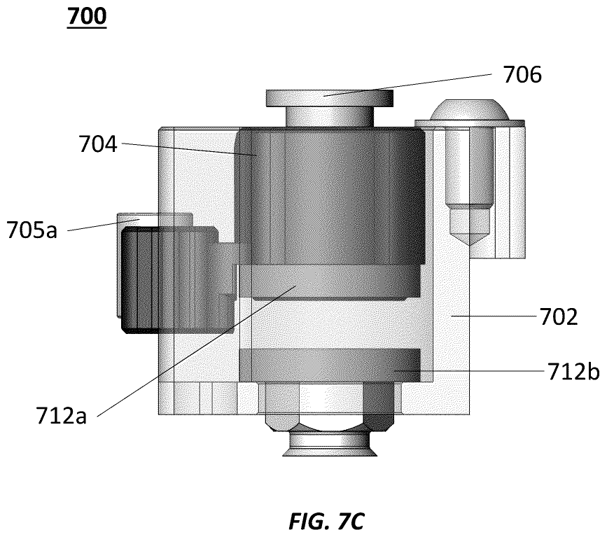

FIGS. 7A-7C illustrate embodiments of path length adjustment devices having a biased sliding component; FIG. 7A illustrates a sliding component and FIG. 7B illustrates a housing where the sliding component sits. With reference to FIG. 7A, sliding component 704 has an inner bushing 706 positioned within the housing that is dimensioned to pass a filament therethrough. The sliding component 704 can include structural features, such as protrusions at its periphery that provide a spacing away from the housing the sliding component 704 sits in and thus a path for debris to be directed away when in operation. As illustrated, the sliding component 704 includes a magnet 705a that is part of a sensor as disclosed herein, e.g., the magnet 705a can induce a transverse electric field in a sensor such as a Hall sensor to produce a voltage change that is directly proportional to the linear position of the sensor. As further illustrated in FIG. 7A, a lower surface of the sliding component 704 includes a plurality of springs 708 positioned at the periphery to provide the bias to the sliding component 704. In operation, the sliding component 704 is compressed down on the springs, which provide an upward force. The sliding component 704 as illustrated is constructed and arranged to fit within housing 702 as illustrated in FIG. 7B. As illustrated in FIG. 7B, the lower surface of the housing 702 includes a spring 701 adapted to receive the sliding component 704 and dimensioned to fit within the space bounded by plurality of springs 708 positioned at the periphery of the sliding component 704. In some embodiments, one of the sliding component 704 or the housing 702 includes springs that provide the bias force against the sliding component 704.

In another embodiment of a biased sliding component, FIG. 7C illustrates a path length adjustment device 700 using magnetic fields to provide bias. With reference to FIG. 7A-7B, the path length adjustment device 700 includes a housing 702 having a sliding component 704 constructed and arranged to translate along a length of the housing 702 and an inner bushing 706 positioned within the housing that is dimensioned to pass a filament therethrough. As illustrated, the sliding component 704 includes a magnet 705a that is part of a sensor as disclosed herein, e.g., the magnet 705a can induce a transverse electric field in a sensor such as a Hall sensor to produce a voltage change that is directly proportional to the linear position of the sensor. Attached to a lower surface of the sliding portion 704 is a first magnet 712a. This magnet is directly opposed to a second magnet 712b attached to an inner surface of the housing 702. The first and second magnets 712a, 712b have their poles aligned such that there is a bias force applied against the sliding component 704 when the first and second magnets 712a, 712b are brought into proximity of their respective magnetic fields.

### EXAMPLES

The function and advantages of these and other embodiments can be better understood from the following examples. These examples are intended to be illustrative in nature and are not considered to be in any way limiting the scope of the invention.

### Example 1—Path Length Adjustment

In this example, the tension of a filament being deposited at a fixed deposition rate was explored.

The print head of the 3D printer used to deposit the test filament included a path length adjustment device positioned on the print head between the pre-extrusion system and the feeding mechanism. The path length adjustment device included an optical sensor positioned towards the bottom of the movable component's motion range to detect the motion and position of the movable component. The movable component included a visual indicium that was detected by the optical sensor when the movable component was close to the bottom of the movable component's motion range. The feed mechanism was set to deposit a test filament at 500 mm/min. During printing, the filament being deposited caused the movable component to move to the bottom of the housing of the path length adjustment device, and the pre-extrusion system was configured to respond to this “bottoming out” by moving the movable component to extend the path length of the filament and add slack to the filament.

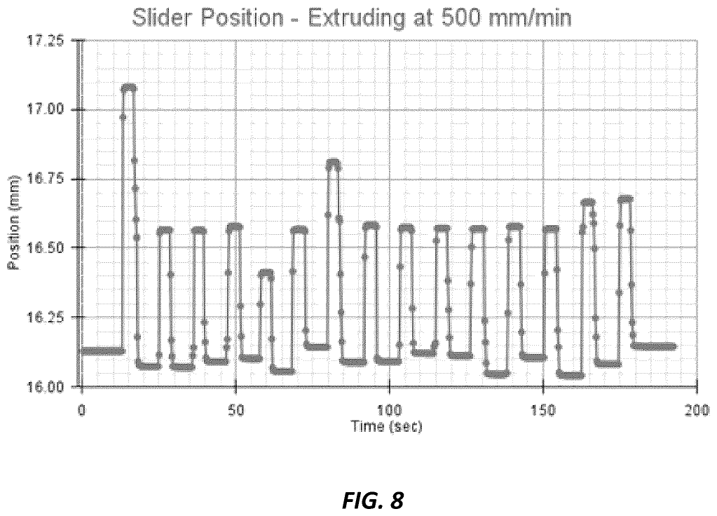

An example of the continuous path length adjustment of the filament being deposited at a fixed rate is illustrated in FIG. 8. In FIG. 8, the position of the movable component over the time of the printing run shows an approximately periodic increase in the position of the movable component. In this case, the feed mechanism was operated at a fixed speed, the speed of the pre-extrusion system was throttled by the position of the movable component within its housing. The increase in position indicates that tension had built up in the filament during printing, with larger positional changes indicating increased tension on the filament. Once slack was made available to the feed mechanism, the position the movable component returned back to a default position.

As discussed herein, and in contrast to existing slack management devices with cumbersome and difficult to seal environments, the path length adjustment system used to produce the data illustrated in FIG. 8, by being positioned on the print head itself which typically operates under controlled conditions, maintains a relatively stable environment around the filament to reduce moisture pickup on the filament. The positioning of the path length adjustment system minimizes exposed filament to the environment and can improve the printing of hygroscopic materials, e.g., nylon and carbon composite filaments. As further discussed herein, the use of path length adjustment system positioned at the print head reduces tension on the feed mechanism at the print head's nozzle outlet, which improves resulting print quality, e.g., excess tension of the filament can result in stretched or broken filaments, impacting printed part dimensionality.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A three-dimensional printer for additive manufacturing of a part comprising:
a build platen;
a pre-extrusion system;
a print head located downstream of the pre-extrusion system and configured to receive and deposit a filament, the print head comprising:
a receiving section configured to receive the filament, the receiving section including an inlet through which the filament is threaded;
an outlet through which the filament is deposited onto the build platen or a previously added layer of a part;
a feeding mechanism constructed and arranged to feed the filament into the outlet; and
a path length adjustment system positioned on the print head, the path length adjustment system constructed and arranged to create slack in the filament being delivered from the pre-extrusion system.

2. The printer of claim 1, wherein the path length adjustment system of the print head comprises:
a housing connected to the print head and comprising an open side and a central space;
a sliding component constructed and arranged translate along the open side of the housing, the sliding component having a first portion that sits within the central space and a second portion that projects away from the open side; and
an inner bushing positioned within the first portion of the sliding component and having a diameter adapted to pass a filament therethrough,
the sliding component adjusting a path length of the filament in response to a pressure on the filament during a printing process.

3. The printer of claim 2, wherein the second portion of the sliding component comprises a magnet disposed along a feed path of the filament through the path length adjustment system.

4. The printer of claim 2, wherein the path length adjustment system has a path length adjustment range of about 0.5 mm to about 1.5 mm.

5. The printer of claim 2, wherein the sliding component is manufactured from a polymer or a metal.

6. The printer of claim 2, wherein the sliding component comprises a component constructed and arranged to provide a bias force in an opposing direction to a filament feed.

7. The printer of claim 6, wherein the component constructed and arranged to provide a bias force comprises a magnet positioned on the sliding component opposing a magnet positioned in the housing.

8. The printer of claim 6, wherein the component constructed and arranged to provide a bias force comprises at least one spring positioned on one or both of the sliding component and the housing.

9. The printer of claim 1, wherein the path length adjustment system of the print head comprises:
a central body having a top, a bottom, and a passage therethrough, the central body aligned with the filament direction through the print head;
a first flexure having a first end connected to the top of the central body and a second end; and
a second flexure having a first end connected to the bottom of the central body and a second end connected to the print head,
the central body pivoting between the first flexure and second flexure to adjust a path length of the filament in response to a pressure on a filament during a printing process.

10. The printer of claim 9, wherein the central body comprises a magnet disposed along a feed path of the filament through the path length adjustment system.

11. The printer of claim 6, wherein the path length adjustment system has a path length adjustment range of about 0.5 mm to about 3.0 mm.

12. The printer of claim 1, wherein the print head further comprises a sensor constructed and arranged to measure the linear position of the path length adjustment system.

13. The printer of claim 1, further comprising a controller constructed and arranged to direct one or both of the feed mechanism and the pre-extruder to feed the filament to the print head.

14. The printer of claim 13, wherein the controller is configured to adjust the feed rate of the printer at one or both of the pre-extrusion system and feeding mechanism based on an output from the sensor in the path length adjustment system.

15. A device for adjusting a filament path length in a three-dimensional printer, comprising a movable component having a passage therethrough and attached to a print head of the printer, the passage sized to pass the filament,
the movable component configured to adjust a path length of the filament in response to a pressure on the filament during a printing process by moving along a long axis of the filament.

16. The device of claim 15, wherein the movable component is disposed within an open sided housing that permits the movable component to translate within the housing.

17. The device of claim 16, wherein the movable component comprises a first portion that sits within the housing and a second portion that projects away from the open side of the housing.

18. The device of claim 17, further comprising an inner bushing positioned within the first portion of the sliding component and having a diameter adapted to pass a filament therethrough.

19. The device of claim 15, wherein the movable component comprises:
a central body having a top, a bottom, and a passage therethrough, the central body aligned with the filament direction through a print head of the three-dimensional printer;
a first flexure having a first end connected to the top of the central body and a second end; and
a second flexure having a first end connected to the bottom of the central body and a second end.

20. The device of claim 15, wherein the movable component provides for a path length adjustment range of about 0.5 mm to about 3.0 mm.

21. The device of claim 15, wherein the movable component is manufactured from a polymer or a metal.

22. The device of claim 15, wherein the movable component comprises a magnet.

23. A device for adjusting a path length in a three-dimensional printer, comprising:
a housing configured to be connected to a print head of a three-dimensional printer, the housing comprising an open side and a central space;
a sliding component constructed and arranged to translate along the open side of the housing, the sliding component having a first portion that sits within the central space and a second portion that projects away from the open side; and
an inner bushing positioned within the first portion of the sliding component and having a diameter adapted to pass a filament therethrough,
the sliding component adjusting a path length of the filament in response to a pressure on the filament during a printing process.

24. A device for adjusting a path length in a three-dimensional printer, comprising:
a central body having a top, a bottom, and a passage therethrough, the central body aligned with the filament direction through a print head of the three-dimensional printer;
a first flexure having a first end connected to the top of the central body and a second end; and
a second flexure having a first end connected to the bottom of the central body and a second end,
the central body pivoting between the first flexure and second flexure to adjust a path length of the filament in response to a pressure on a filament during a printing process.

25. The printer of claim 2, wherein the sliding component comprises a component constructed and arranged to provide a bias force a direction aligned to a filament feed direction.
